(19) United States
(12) Patent Application Publication
(10) Pub. No.: US 2014/0067776 A1
(43) Pub. Date: Mar. 6, 2014

(54) Method and System For Operating System File De-Duplication

(71) Applicant: Confio Corporation, Boulder, CO (US)

(72) Inventors: Matthew Donald Larson, Erie, CO (US); Brett Derek Hawton, Alamo, CA (US)

(73) Assignee: CONFIO CORPORATION

(21) Appl. No.: 14/010,385

(22) Filed: Aug. 26, 2013

Related U.S. Application Data
(60) Provisional application No. 61/694,629, filed on Aug. 29, 2012.

(51) Int. Cl. G06F 17/30

(52) U.S. Cl. CPC G06F 17/30156
USPC 707/692

(57) ABSTRACT

When one considers all of the servers at an organization, the exact same operating system and application files will appear on many of them. Thus, there is an opportunity for saving an enormous amount of disk space for the organization as a whole by de-duplicating stored files. The present invention addresses the above needs by providing a method and system for saving at least one copy of a duplicate file in a location on a common storage system accessible to all relevant server computers and then removing the duplicates from the storage allocated to each server. Whenever the operating system on a server whose duplicate file has been removed requires access to the file, then the method redirects the operating system to access the file from the common storage system file location.

### CROSS-REFERENCE TO RELATED APPLICATIONS

This application claims the benefit of U.S. provisional patent application No. 61/694,629, filed Aug. 29, 2012. U.S. provisional patent application No. 61/694,629 is specifically incorporated by reference herein.

### FIELD OF THE INVENTION

The present invention generally relates to file management system software and the method used to store, read and write files across multiple server computers. Specifically it relates to server computer software implemented at an operating system file driver level to intercept and redirect reads and writes to specific files so that the reads and writes to files are actually made from or to a physically different location from where the operating believes the files reside.

### BACKGROUND OF THE INVENTION

Typically midsized and larger organizations have hundreds or even thousands of server computers with each server running perhaps a few different software applications. Despite the many different applications these many servers are running, if one looks across an organization most of these servers are, in aggregate, running just two or three underlying operating systems (e.g. Microsoft Windows, Linux etc.) and for each of these operating systems an organization may not be running more than three to four variants or versions across the entire organization (e.g. On Microsoft Windows the variants would usually be Windows 2003, Windows 2008, Windows 2008 R2, Windows 2012).

Despite an operating system such as Windows having a number of versions, many of the operating system level executables (programs), DLLs, images and other file types are the same across versions. Also many of the applications these servers are running are the same across servers and hence also have the same executables.

In summary then, when one considers all of the servers at an organization, the exact same operating system and application files will appear on many of them. Modern server farms are connected to just one or perhaps two common storage systems (e.g. SAN or NAS storage). So in effect one storage system may have several thousand copies of the same executable, DLL, image or other file type. Thus, there is an opportunity for saving an enormous amount of disk space for the organization as a whole by de-duplicating stored files.

### SUMMARY OF THE INVENTION

The present invention addresses the above needs by providing a method for utilizing an operating system level file driver for providing file de-duplication on multiple server computers. In accordance with the method, at least one duplicate file on more than one of the multiple servers is determined to be removed. A copy of the duplicate file is stored on a common storage area accessible to all multiple server computers. The duplicate file is removed from the more than one of the multiple server computers and information about the removed duplicate file is stored.

In accordance with another aspect of the present invention, the method for utilizing an operating system level file driver for providing file de-duplication on multiple server computers includes, providing that the methods for determining the at least one duplicate file that should be removed include referencing a white list and referencing a black list. Yet other aspects of the present invention include providing that the methods for determining the at least one duplicate file that should be removed include monitoring access to a file not on a white list not a black list, over a defined time period to determine read only access.

In accordance with another aspect of the present invention, the method for utilizing an operating system level file driver for providing file de-duplication on multiple server computers includes, providing storing information about the removed duplicate file include storing a stub in place of the removed duplicate file, the stub containing at least one identifying attribute of the removed duplicate file. In yet other aspects of the present invention include providing storing an inventory including at least one identifying attribute of all of the removed duplicate files.

In accordance with another aspect of the present invention, the method for utilizing an operating system level file driver for providing file de-duplication on multiple server computers includes replacing the removed duplicate file back onto the more than one server in response to receiving a request to replace the removed duplicate file.

In accordance with another aspect of the present invention, the method for utilizing an operating system level file driver for providing file de-duplication on multiple server computers includes, in response to receiving a request to update a removed duplicate file, replacing the removed duplicate file and performing the update on the requesting server computer's replaced file.

In accordance with another aspect of the present invention, the method for utilizing an operating system level file driver for providing file de-duplication on multiple server computers includes, upon receiving a request to read a removed duplicate file, redirecting the read to the common storage area where the copy of the removed duplicated file is stored.

In accordance with another aspect of the present invention, the method for utilizing an operating system level file driver for providing file de-duplication on multiple server computers includes, in response to receiving a request to update a removed duplicate file, determining that there is no copy of the removed duplicate file with the update already applied on the common storage area, and creating the updated copy of the removed duplicate file on the common storage area.

In accordance with another aspect of the present invention, the method for utilizing an operating system level file driver for providing file de-duplication on multiple server computers includes, providing a version history common storage area accessible to all of the multiple server computers, storing copies of changed blocks of the updated copy of the removed duplicate file on the version history common storage area, and storing copies of unchanged blocks of the removed duplicate file on the common storage area.

In accordance with another aspect of the present invention, the method for utilizing an operating system level file driver for providing file de-duplication on multiple server computers includes, providing adding at least one additional common storage area and communicating the existence of the at least one additional common storage area to the existing common storage area and multiple server computers.

In accordance with another aspect of the present invention, the method for utilizing an operating system level file driver for providing file de-duplication on multiple server computers includes, providing storing a copy of the removed duplicate file on more than one common storage area accessible to the multiple server computers.

In accordance with additional aspects of the present invention, a multiple server computer system, a server computer, and computer readable medium for performing the methods described above for providing file de-duplication utilizing an operating system level file driver.

Thus, the invention provides a method and system for providing utilization of an operating system level file driver for file de-duplication on multiple server computers and provides benefits by dramatically reducing the storage requirements over all of the many server computers at a typical computer site.

### BRIEF DESCRIPTION OF THE DRAWINGS

The foregoing aspects and many attendant advantages of this invention will become more readily appreciated by reference to the following detailed description, when taken in conjunction with the accompanying drawings, wherein:

FIG. 1 is a block diagram of a representative multiple server computer system environment in which the invention may be implemented;

FIG. 2 is a flow diagram illustrating a routine for providing file de-duplication on multiple server computers;

FIG. 3 is a flow diagram illustrating a routine for accessing de-duplicated files, including access to replace, read, backup, and update in rehydrate mode the de-duplicated files;

FIG. 4 is a flow diagram illustrating a routine for updating de-duplicated files in the non-rehydrate mode;

FIG. 5 is a flow diagram illustrating a routine for maintaining common storage areas;

FIG. 6 is a flow diagram illustrating a routine for providing high-availability option;

FIG. 7 is a flow diagram illustrating a routine for providing version history common storage area; and

FIG. 8 is a flow diagram illustrating a routine for providing a centralized console for user settings and control across server computers;

### DETAILED DESCRIPTION OF THE PREFERRED EMBODIMENT

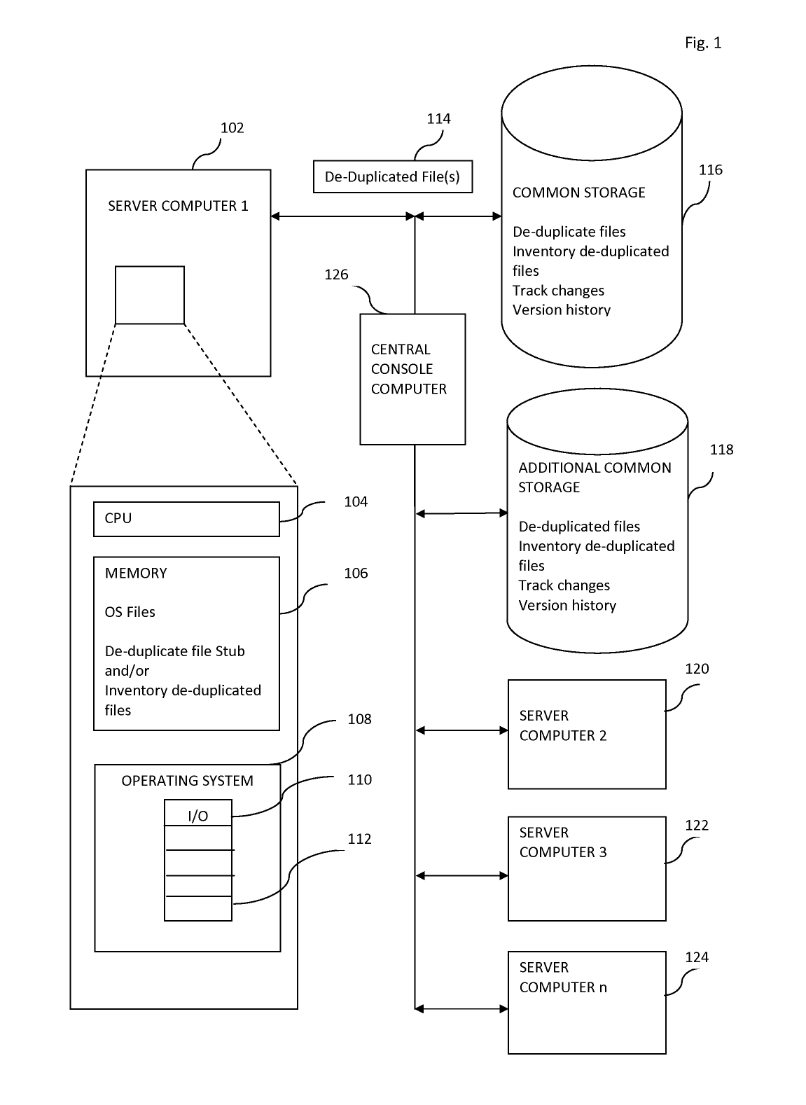

FIG. 1 illustrates an example of a suitable computing system environment in which the invention may be implemented. The computing system environment is only one example of a suitable computing environment and is not intended to suggest any limitation as to the scope of use or functionality of the invention. Neither should the computing environment be interpreted as having any dependency requirement relating to any one or combination of components illustrated in the exemplary operating environment.

The invention may be described in the general context of computer-executable instructions, such as program modules, being executed by a computer. Generally, program modules include routines, programs, objects, components, data structures, etc. that perform a particular task or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With reference to FIG. 1, an exemplary system for implementing the invention includes a general-purpose computing device in the form of a server computer 102. Components of a server computer 102 include, but are not limited to, a central processing unit (CPU) 104, a system memory 106. The system memory 106 includes computer storage media in the form of volatile and/or nonvolatile memory, such as read-only memory and random-access memory. The server computer 102 operates in a network environment using logical connections to one or more remote computers, including server computers 120-124 and central console computer 126. The remote computer may be a personal computer, a server, a router, a network PC, a peer device or other common network node, and typically includes many or all of the elements described above relative to server computer 102. The logical connections include a local area network (LAN) and wide area network (WAN), but also include other networks. Such network environments are commonplace in office, enterprise-wide computer networks, intranets, and the Internet.

The server computer includes a list of I/O device drivers 110 and 112, which are installed software routines for enabling the computer to transmit and receive data to and from input/output devices depending on the current situation. The server computer 102 is connected to computer data storage device 116 and computer data storage device 118. Computer data storage device 116 may store a database, which are files composed of records each containing fields together with a set of operations for search, sorting, recombining, and other functions. The database management system is a software interface between the database and the user. A database management system handles user requests for database actions and allows for control of security and data integrity requirements. The database management system is sometimes referred to by the acronym DBMS and is also sometimes called the database manager. A database server is a network node or station dedicated to storing and providing access to a shared database. The database machine is a peripheral that executes data set tasks, thereby relieving the main computer form performing them. A database machine is also referred to as a database server and performs only database tasks. A database structure is a general description of the format of records in a database, including the number of fields, specifications regarding the typed of data that can be entered in each field, and the fields names used.

Data storage device 116 may store a special type of database called relational database. A relational database is a database or database management system that stores information in tables—rows and columns of data—and conducts searches by using data in specified columns of one table to find additional data in another table. In a relational database the rows of a table represent records (collections of information about separate items) and the columns represent fields (particular attributes of a record). In conducting searches, a relational database matches information from a field in one table with information in a corresponding field of another to produce a third table that combines requested data from both tables.

The server computer 102 uses logical connections to one or more data storage devices to transmit information to the data storage devices. The information transmitted includes de-duplicated files 114 to be stored in the data storage device 116 and data storage device 118. The logical connections include a local area network (LAN) and wide area network (WAN), but also include other networks. Such network environments are commonplace in office, enterprise-wide computer networks, intranets, and the Internet.

The server computer 102 includes an operating system 108, which is software that controls the allocation and usage of hardware resources such as memory, central processing unit (CPU) 104, disk space, and peripheral devices. The operating system is the foundation software on which applications depend. Popular operating systems include Windows 7, Windows Vista, Windows XP, Linux, Mac OS X, and Unix.

Using an operating system level file driver such as an IO driver, IO filter driver, Linux user space driver, re-parser, redirector or other similar such techniques (hereafter referred to as IO Driver for brevity) this invention seeks to reduce the number of duplicate files, especially read-only type files, used by a collection of servers (also referred to as server computers interchangeably herein) so that only a single such file is kept on the common storage space (common storage space, common storage system, common storage area, and common repository are used interchangeably herein) assessable to these servers. Such a de-duplication topology would dramatically reduce the amount of storage required at a typical computer site having many such servers.

The method by which a particular operating system on a computer whose files are to be de-duplicated is initially informed about a common storage system (or more than one common storage system where the high-availability option is used, as described herein below) where de-duplicated files may be found and the method by which the operating system stores this common storage system information is such that it can be accessed whenever the computer or operating system is rebooted or restarted. Even in scenarios where the operating system starts in modes other than Normal, such as Safe Mode this invention will operate normally and access de-duplicated, and hence removed files.

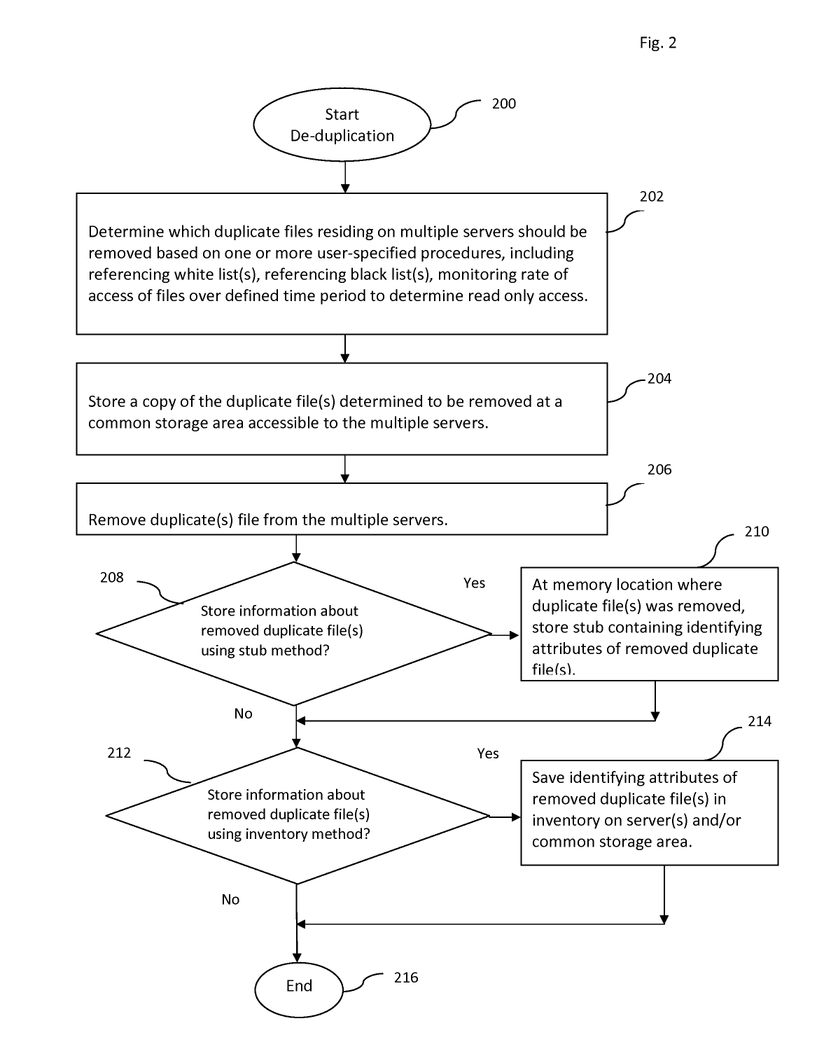

Generally described, FIG. 2 is a flow diagram illustrating a routine 200 utilizing an operating system level driver for providing file de-duplication on multiple server computers. Referring to FIG. 2, at block 202 a determination is made as to which files residing on the multiple server computers allocated memory are duplicates and should be removed.

The method by which the IO driver determines which file should be removed from the file subsystem of a particular server operating system and be moved and then accessed from a common storage space accessible by all servers in the cluster can be any combination of one or more of the following procedures described below. When referring herein to removing a file from a server computer, it includes removing the file from the server computer memory, removing the file form memory that is allocated to the server, and removing the file from the server computer's file subsystem.

One procedure for determining which file should be removed from the file subsystem of a particular server operating system includes referencing a user defined white list of file names and file extensions (including wild cards of both portions of the name and extension) of files which should be allocated to this de-duplication storage topology.

Another procedure for determining which file should be removed from the file subsystem of a particular server operating system includes referencing a user defined black list of file names and file extensions (including wild cards of both portions of the name and extension) of files which should not be allocated to this de-duplication storage topology. Examples of files which may appear on this list may be some operating system files which are involved in instantiating the IO driver after startup and hence cannot be de-duplicated and removed by the IO driver from the file subsystem of a particular operating system.

Another procedure for determining which file should be removed from the file subsystem of a particular server operating system includes monitoring access to other files not on the white or black list over some user-defined length of time and determining that access is read-only and optionally perhaps meets some minimum or maximum rate of IO operations over a defined period of time. The IO driver itself could add files to the white list. Once one (or some other user defined number) other IO driver(s) on different server(s) reports the same file then that file could be de-duplicated by removing it from each of the servers and saving one copy of the file on the common storage space.

Referring to FIG. 2, at block 204 a copy of the one or more duplicate files that were determined to be removed are stored at a common storage area accessible to all the multiple server computers. Thus, when a file is deemed eligible to be removed its contents are first moved and saved to a common storage space (or more than one common storage space, if the high-availability common storage feature is used, as described herein below). After saving a copy of the one or more duplicate files at the common storage area, routine 200 proceeds to block 206 and the duplicate file is removed from the file subsystem of each of the particular server computers whose file was determined to be a duplicate and eligible for removal. The invention then provides two methods of keeping track of the deleted files, which are described below with reference to FIG. 2, blocks 208-214.

Referring to FIG. 2, at decision block 208 routine 200 determines if the stub method of keeping track of the deleted files is desired. If so, routine 200 proceeds to block 210. A “stub” is left in place of the deleted file. This stub contains combinations of one or more identifying attributes such as file name, creation date, date modified, and size. Alternatively or in addition the stub could carry a hash value either created from the values mentioned above or it could be a global unique ID generated by the common storage system. This stub can be accessed by the IO Driver. After storing a stub at the memory location where each duplicate file was removed at block 210, then processing proceeds to decision block 212. If the stub method was determined not to be used at decision block 208 then processing continues to decision block 212.

Referring to FIG. 2, at decision block 212 routine 200 determines if the inventory method of keeping track of the deleted files is desired. If so, routine 200 proceeds to block 214. An inventory (in an internal table, database or registry hive) is kept of which files (and their attributes such as creation date, size, and other attributes known by those skilled in the relevant art.) have been deleted and moved to the common storage space. The invention allows for this inventory to be kept either on each individual server itself or for all the relevant servers on some common storage system. This invention also allows for this inventory to be kept on some specified servers themselves and on some common storage space for the other relevant servers.

After storing saving identifying attributes of removed duplicate file(s) in an inventory on the server(s) and/or common storage area at block 210, then processing ends at block 216. If it was determined that the inventory method was not to be used at decision block 212, then processing ends at block 216.

All of the present inventions methods for tracking deleted files (and the underlying lists) can use any combination of one or more identifying attributes to determine the uniqueness of a particular file and hence its eligibility to be de-duplicated with other like files from different server systems. For example, the identifying attributes used may include any combination of one or more of the following: File name, Creation Date, Date Modified, Size, Owner, Author, An intermediate hash containing some of the values above in order to determine the likelihood of a potential match early in the process, and Direct byte comparison of the contents of the file.

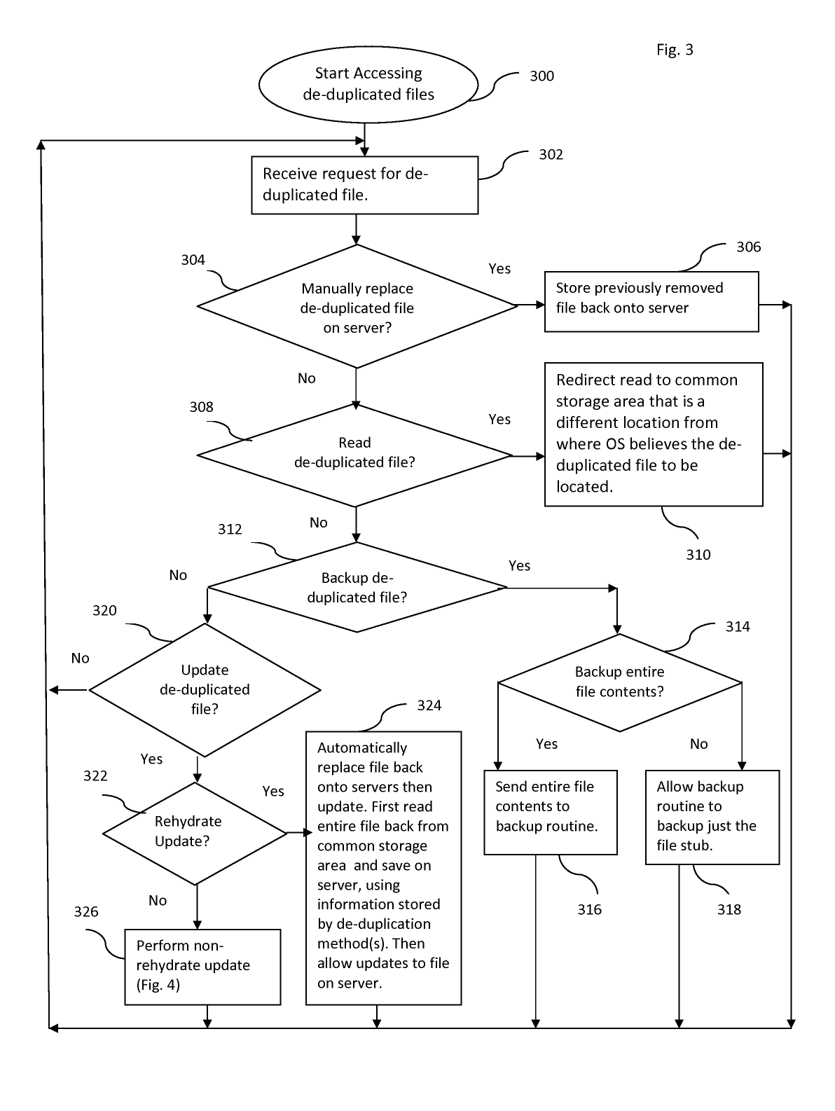

Turning now to FIG. 3, which generally described, is a flow diagram illustrating a routine 300 for accessing de-duplicated file(s). After receiving a request for a de-duplicated file at block 302, processing continues to decision block 304 where it is determined if the request is to manually replace the de-duplicated file back onto the server. If so, processing proceeds to block 306 and the previously removed file is stored back onto the server. The present invention provides that one file, a selection of files, or all files which have been previously removed from a particular server system during the de-duplication process described above can be replaced back onto the server system. This process can be started manually based on a user request (block 306) or automatically whenever the server operating system attempts to perform an update against the contents of the de-duplicated file (described below with reference to block 324). After replacing the duplicate file at block 306, routine 300 repeats to process another request.

If at decision block 304, it was determined that the request was not for manually replacing the de-duplicate file then processing continues to decision block 308. At decision block 308 it is determined if the request is to read the de-duplicated file. If so, processing proceeds to block 310 otherwise processing proceeds to decision block 312. At block 310, the operating system, on a server whose duplicate file has been removed, request to read the file is redirected to read the duplicate file from the common storage system file location. After redirecting the read access request at block 310 routine 300 repeats to process another request.

If at block 308 it was determined that the request is not to read a de-duplicate file then processing continues to decision block 312. At decision block 312 it is determined if the request is to backup a de-duplicated file. If so, processing proceeds to decision block 314. At decision block 314 it is determined if the entire contents of the duplicate file is to be backed up. If so, processing proceeds to block 316 and the entire contents are sent to the requesting backup routine. Otherwise, when it was determined that the entire contents are not to be backed up, processing proceeds to block 318 and the requesting backup routine is allowed to backup just the file stub. After backing up the entire file contents at block 316 or just the file stub at block 318, routine 300 repeats to process another request.

As described above, with reference to blocks 314-318, the present invention provides methods for handling server operating system and other backup regimes. The user is able to specify (e.g. via a setting) that, when the backup calls for the de-duplicated file, either the entire contents of the de-duplicated file should be sent to the backup routine or that the backup routine should simply be allowed to backup just the file “stub”.

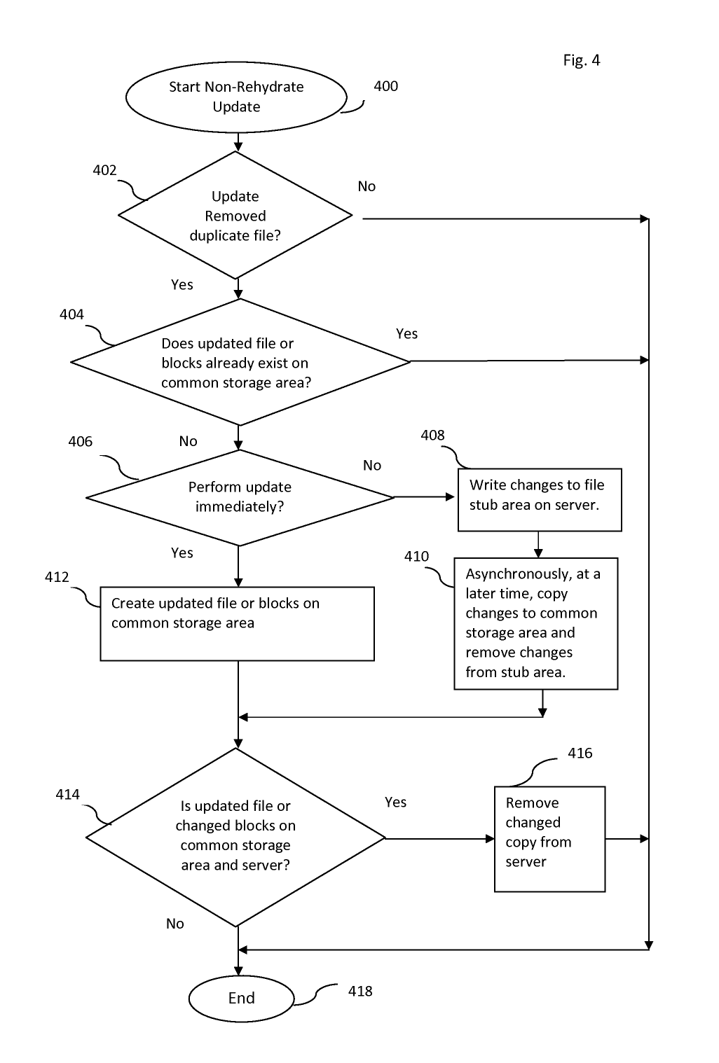

If at block 312 it was determined that the request is not to backup a de-duplicated file, then processing continues to decision block 320. At decision block 320 it is determined if the request is to update and/or write to a de-duplicated file. If so, processing proceeds to decision block 322, otherwise routine 300 repeats to process another request. At decision block 322 a determination is made as to whether the user has specified the rehydrate update option. Typically the user will specify to update in the rehydrate mode where the de-duplicated file automatically replaced back onto the relevant servers from which the file was removed and the updates are performed on the relevant server. If the rehydrate option is determined to be specified, then processing proceeds to block 324 and the de-duplicated file is automatically replaced using the information provided by the de-duplication methods used, such as the stub method, the inventory methods, and the lists methods. The entire de-duplicated file is read back from the common storage area and stored back on to the relevant server and the updates are allowed on the server. After the update changes are written to the replaced file stored on the relevant servers and routine 300 repeats to process another request. If at some stage in the future the replaced file is opened in the read only move then it may again be du-duplicated using the de-duplication methods provided by the present invention and described herein. However, if at decision block 322 it was determined that the user had not specified the rehydrate update option, then processing proceeds to block 326 where the non-rehydrate update request is processed as described below with reference to FIG. 4.

As described with reference to blocks 322-324, this invention provides user settable options which allow the server system to handle writes and updates to a de-duplicated file to by simply rehydrating a previously de-duplicated file once it is opened for write and/or update access. This rehydration can be performed synchronously or asynchronously after the fact and therefore will contain the information used by the methods described above (stub, inventory, lists, etc.) as a way to determine what parts of the file have changed and therefore must not be rehydrated.

Generally described, FIG. 4 is a flow diagram illustrating a routine 400 for updating de-duplicated files in the non-rehydrate mode. At decision block 402 it is determined if the request is to update a removed duplicate file. If so, processing proceeds to decision block 404, otherwise routine 400 ends at block 418 and the update request is processed conventionally. At decision block 404, a determination is made as to whether the updated file or changed blocks already exist on a common storage area. If so, then the update is already performed and routine 400 proceeds to end at block 418. Otherwise, if it was determined that the updated file or changed blocks do not already exist on a common storage area then routine 400 continues to decision block 406. At decision block 418 it is determined if the update is specified to be performed immediately. If the update is not to be performed immediately, but rather asynchronously in a delayed manner, then processing proceeds to block 408. At block 408, the changes are written to the file stub area on the relevant server. After writing the changes to the stub area at block 408, processing continues to block 410. At block 410 the changes are later copied to common storage area asynchronously. After copying the changes to the changes to the common storage area, the changes written to the stub area are removed and processing continues to decision block 414. If the update was determined to be performed immediately at decision block 406, then routine 400 proceeds to block 412 and creates the updated file or changed blocks on the common storage area. After creating the updated file or changed blocks on the common storage area, processing continues to decision block 414. At decision block 414, a determination is made as to whether there is still an updated file or changed blocks on both the common storage area and a server. If so the updated file or changed blocks on the server are removed. After removing the copy found on the server or determining that there was no copy on the server, routine 400 ends at block 418.

As described above with reference to blocks 402-416 the present invention provides methods for updating de-duplicated files stored on the common storage area. Should one server system wish to update its copy of a file, for example during an operating system upgrade, then this invention checks to see if the updated file or the changed blocks of the file already exist on the common storage space. If the updated file or changed blocks of the file do not already exist on the common storage space, then the updated file or changed blocks of the file will be created on the common storage space. The creation of the updated file or changed blocks of the file may be performed either immediately or in a delayed manner. The delayed manner is accomplished by first writing the changes into the file stub area on the server system and then moving those changes to the common storage space asynchronously at a later time and removing them from the stub area. After either finding the updated file or changed blocks of the file on the common storage space or creating the updated file or changed blocks on the common storage space, the changed copy of the file on the server system is removed, if one exists.

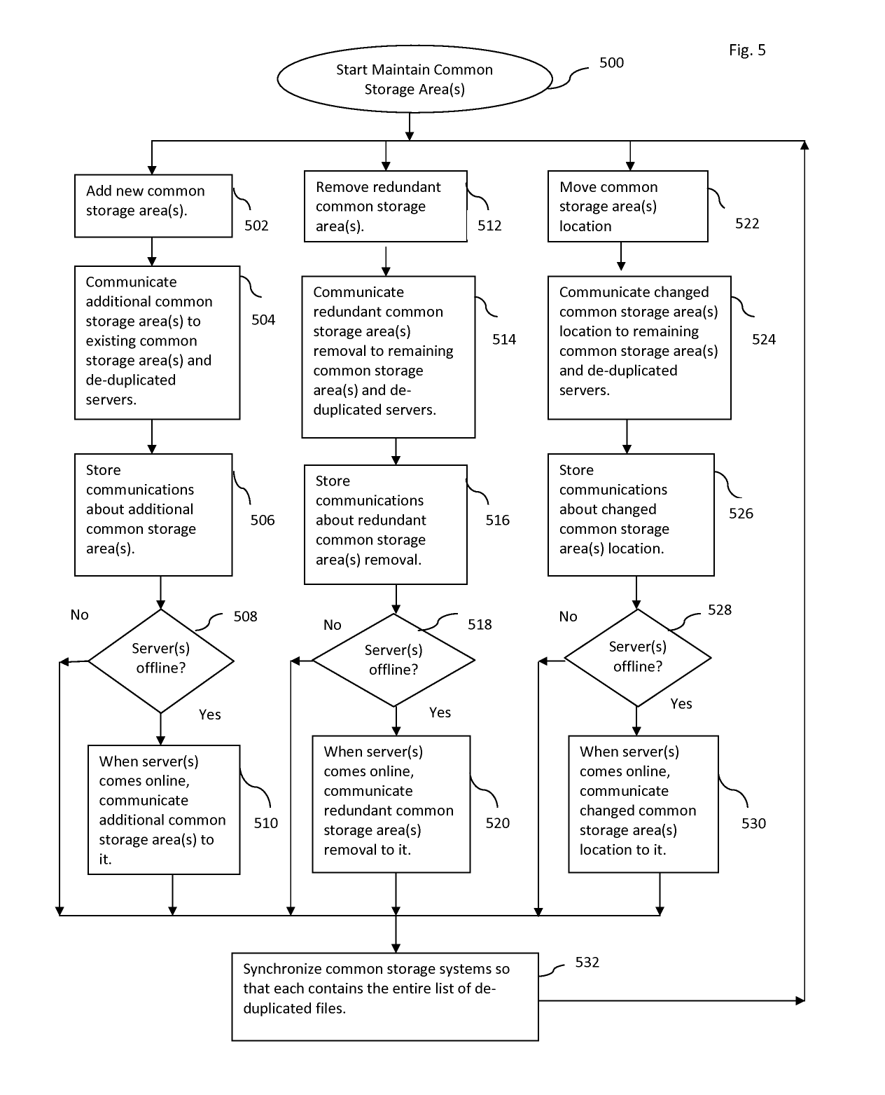

Turning now to FIG. 5, which generally described is a flow diagram illustrating a routine 500 for maintaining common storage areas. At block 502, routine 500 provides for adding a new common storage area. After adding the additional common storage area, processing continues to block 504 where the existence of the additional common storage area is communicated to the existing common storage area(s) and relevant, de-duplicated servers. Next, at block 506, communications about the additional common storage area are stored. After storing the communications processing proceeds to decision block 508. At decision block 508 a determination is made as to whether a server was offline when the new common storage area was added. If so, processing continues to block 510 and, when the server comes back online, routine 500 communicates the additional common storage area to it. After providing the previously offline server with the new common storage area communications, processing continues to block 532. If at decision block 508, it was determined that no servers were offline then processing proceeds directly to block 532. At block 532, routine 500 synchronizes the common storage systems by storing on each a copy of the entire list of de-duplicated files. After synchronizing the common storage areas at block 532, routine 500 repeats to continue providing common storage area maintenance features.

Routine 500 continues to provide common storage area maintenance features at block 512 where removal of a redundant common storage area is provided. After removing the redundant common storage area, processing continues to block 514 where the removal of the redundant common storage area is communicated to the existing common storage area(s) and relevant, de-duplicated servers. Next, at block 516, communications about the redundant common storage area removal are stored. After storing the communications processing proceeds to decision block 518. At decision block 518 a determination is made as to whether a server was offline when the redundant common storage area was removed. If so, processing continues to block 520 and, when the server comes back online, routine 500 communicates the redundant common storage area removal to it. After providing the previously offline server with the redundant common storage area removal communications, processing continues to block 532. If at decision block 518, it was determined that no servers were offline then processing proceeds directly to block 532. At block 532, routine 500 synchronizes the common storage systems by storing on each a copy of the entire list of de-duplicated files. After synchronizing the common storage areas at block 532, routine 500 repeats to continue providing common storage area maintenance features.

Routine 500 continues to provide common storage area maintenance features at block 522 where moving the location of a common storage area is provided. After moving the location of a common storage area, processing continues to block 524 where new location of the common storage area is communicated to the existing common storage area(s) and relevant, de-duplicated servers. Next, at block 526, communications about the new location of the common storage area are stored. After storing the communications processing proceeds to decision block 528. At decision block 528 a determination is made as to whether a server was offline when the common storage area location was moved. If so, processing continues to block 530 and, when the server comes back online, routine 500 communicates the new common storage area location to it. After providing the previously offline server with the new common storage area location communications, processing continues to block 532. If at decision block 528, it was determined that no servers were offline then processing proceeds directly to block 532. At block 532, routine 500 synchronizes the common storage systems by storing on each a copy of the entire list of de-duplicated files. After synchronizing the common storage areas at block 532, routine 500 repeats to continue providing common storage area maintenance features.

As described above, with reference to blocks 502-532, this invention provides for the ability to add additional common storage systems and to make the existing common storage systems aware of the new common storage systems. This invention also provides for the ability to propagate the fact that there is an additional common storage system to all the participating de-duplicated servers and to keep track of such communications such that if a server is offline at present that as soon as it becomes online again then the fact that there is a new common storage system is propagated to it. All of the common storage systems can be synchronized such that each common storage system contains the entire list of de-duplicated files. This invention also provides the ability to remove a redundant common storage system and communicate that change to the other remaining common storage systems. This invention also provides for the ability to propagate the fact that a common storage system has been removed to all the participating de-duplicated servers and to keep track of such communications such that if a server is offline at present then as soon as it becomes online again the fact that a common storage system has been removed is propagated to it. Thus, even in scenarios where the operating system starts in modes other than Normal, such as Safe Mode this invention will operate normally and access de-duplicated, and hence removed file. This invention additionally provides for the ability to move the location of an existing common storage system and communicate that move to the other remaining common storage systems as well as all server systems that have files de-duplicated on that common storage space.

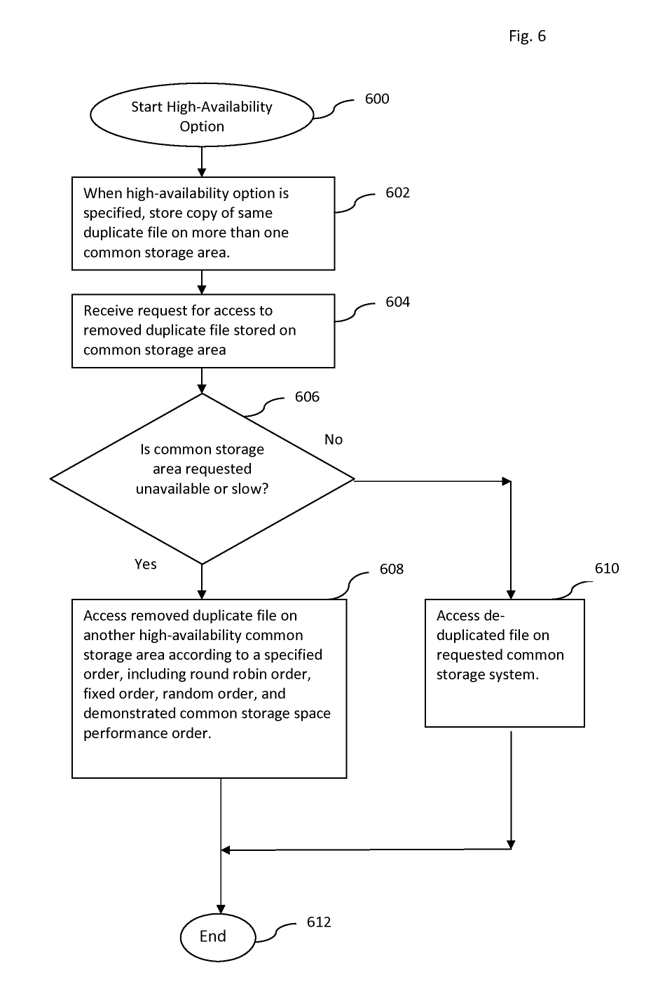

Generally described, FIG. 6 is a flow diagram illustrating a routine 600 for providing the high-availability option of the present invention. Referring now to FIG. 6, at block 602, when the high-availability option is specified, the present invention provides for storing the same copy of the removed duplicate file on more than one common storage area. Next, at block 604, the routine 600 receives a request for accessing the removed duplicate file stored on more than one common storage area. Proceeding to decision block 606, a determination is made as to whether the requested common storage area, where a copy of the requested removed duplicate file is stored, is temporarily unavailable or is experiencing slow performance. If so, processing proceeds to block 608 and routine 600 provides access to the removed duplicate file on another high-availability common storage area. The order that the other high-availability common storage areas are accessed can be specified by the user. The user can specify the access order to be round robin, fixed order, random order, and a demonstrated common storage performance order. However, these access orders are examples of the access orders a user may specify. The present invention is not limited to these access orders and includes providing any and all access orders that are known to those of ordinary skill in the relevant art. After accessing the removed duplicate file stored on the high-availability common storage area, routine 600 ends at block 612. If at decision block 606 it was determined that the requested common storage area was not temporarily unavailable or very slow, then processing proceeds to block 610. At block 610, the requested removed duplicate file is accessed at the requested common storage area. After accessing the removed duplicate file at the requested common storage area at block 610, routine 600 ends at block 612.

As described above with reference to blocks 602-612, the present invention a high-availability option that allows the de-duplicated files to be held in more than one common storage space such that if one common storage space is temporarily unavailable or very slow due to excessive access then the same files can be accessed from the other common storage spaces. The order in which each server system accesses the various high-availability common storage spaces is controlled by user settings. For purposes of example only and are not intended to be limitations on the scope of this invention, some of the access orders that a user may specify are as follows: Round robin, Fixed order list, Random order, and Demonstrated common storage space performance.

Even in scenarios where the operating system starts in modes other than Normal, such as Safe Mode this invention will operate normally and access de-duplicated, and hence removed files.

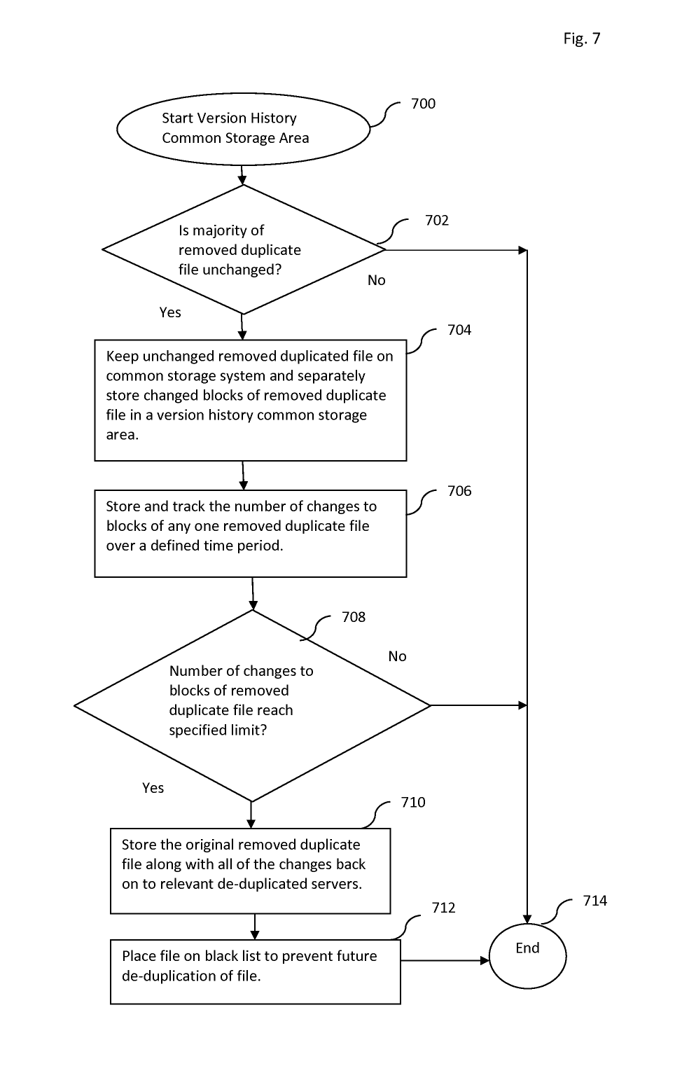

Generally described, FIG. 7 is a flow diagram illustrating a routine 700 for providing a version history common storage area. Referring to FIG. 7, at decision block 702 a determination is made as to whether the majority of a removed duplicate file is unchanged. If so, processing continues to block 704, otherwise routine 700 ends at block 714. At block 704 the unchanged de-duplicated file (the terms de-duplicated file and removed duplicate file refer to the same file and are used interchangeably herein) is kept on the common storage area and the changed blocks of the removed duplicate file are stored separately in a version history common storage area. Next, processing proceeds to block 706 and the number of changes to blocks of the removed duplicate file are stored and tracked over a defined period of time. Continuing to decision block 708, a determination as to whether a user specified limit on the number of changes to blocks of the removed duplicate file have been reached. If so, processing continues to block 710, otherwise routine 700 ends at block 714. At block 710, the original removed duplicate file, along with all of the changes, are stored back on to the de-duplicated servers that are using the same file. Next, routine 700 continues to block 712 and the places the file on a black list so as to prevent future de-duplication of the file. After adding the file to the black list, routine 700 ends at block 714.

As described above with reference to blocks 702-712, the present invention allows for writes to a de-duplicated file where the updated blocks of the file are kept in a version history common storage space such that the majority of the file which has not been changed is kept in the de-duplicated common storage spaces and the changes to each file are kept separate. This invention provides for ensuring that, should the number of changes to the blocks in any one file on a server system (or a number of server systems) over a defined period of time reach certain user settable high-water marks, then, rather than continuing to track changes in a version history common storage space that the original file (with all of its changes) is placed back on the server system (or many server systems in an environment where many server systems are using the same file). In this scenario, the file is added to the black-list such that no further de-duplication techniques will be used on that particular file.

This invention further provides user settable options which allow the server system to switch from the methods described above in handling writes to a de-duplicated file to instead simply rehydrate a previously de-duplicated file once it is opened for write access. This rehydration can be performed synchronously or asynchronously after the fact and therefore will contain the information used by the methods described above (stub, inventory, lists, etc.) as a way to determine what parts of the file have changed and therefore must not be rehydrated.

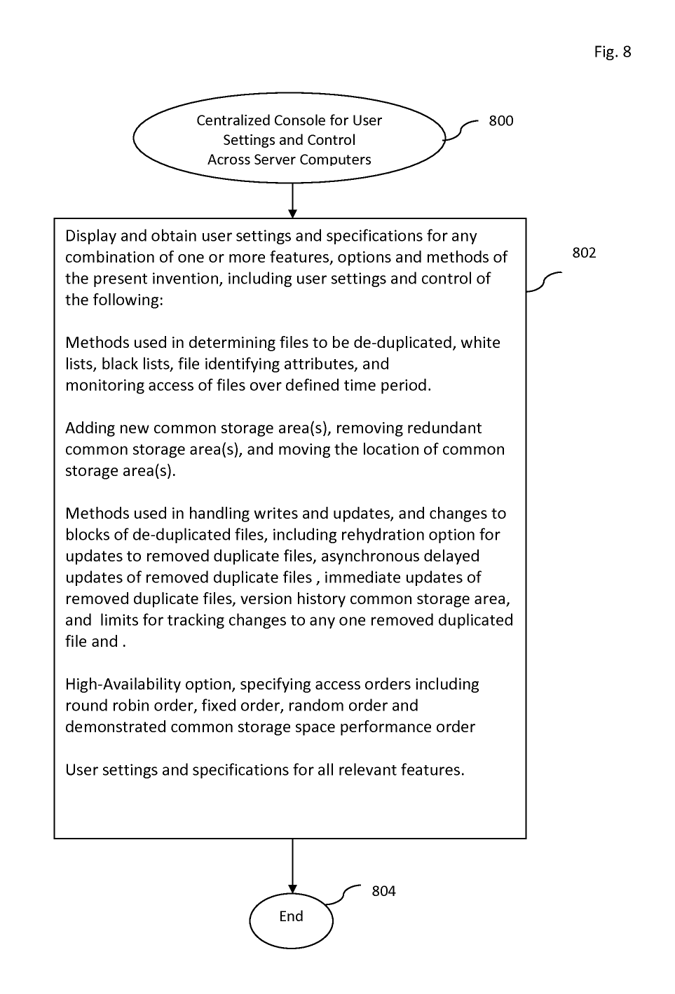

Generally described, FIG. 8 is a flow diagram illustrating a routine 800 for providing a centralized console for user settings and control across server computers for all of the features provided by the present invention and described herein. Referring to FIG. 8, at block 802, routine 800 utilizing a centralized console displays and obtains the settings and controls across the multiple server computers. Any combination of one or more of the many features, options and settings of the present invention are included in the display as desired by the user. Thus, as described above, the present invention provides for a centralized console which allows users to control and observe all of the features described above across all of the servers in an organization.

The embodiments of the invention in which an exclusive property or privilege is claimed are defined as follows:

1. A method for utilizing an operating system level file driver for providing file de-duplication on multiple server computers, the method comprising:
determining at least one file duplicated on more than one of said multiple server computers;
storing a copy of said duplicate file on a common storage area accessible to said multiple server computers;
removing said duplicate file from more than one of said multiple server computers; and
storing information about said removed duplicate file.

2. The method of claim 1, wherein said duplicate file is a read only file type.

3. The method of claim 1, wherein said stored information about said removed duplicate file contains identifying file attributes including any combination of one or more of the following:
(a) file name;
(b) file extension;
(c) file name having wild card portion therein;
(d) file extension having wild card portion therein;
(e) file size;
(f) global unique identifier; and
(g) hash value created from file identifying information.
(h) file creation date;
(i) date file modified;
(j) file owner;
(k) file author; and
(l) direct byte comparison of file contents.

4. The method of claim 1, wherein determining said at least one duplicate file includes referencing any combination of one or more of the following lists:
(a) a white list of at least one file that should be de-duplicated; and
(b) a black list of at least one file that should not be de-duplicated.

5. The method of claim 4, wherein determining said at least one duplicate file includes an operating system level driver of one of said multiple server computers monitoring access, over a defined time period, to a file not on said white list nor said black list, and determining based on said monitoring that said file is read only access.

6. The method of claim 5, further comprising another said operating system level driver of one of said multiple server computers also determining that the same said file is read only access, and adding said same read only access file to said white list.

7. The method of claim 1, wherein storing information about said removed duplicate file includes storing on each of said more than one multiple server computers from which said duplicate file was removed, a stub in place of said removed duplicate file, said stub including at least one identifying attribute of said removed duplicate file.

8. The method of claim 7, further comprising, in response to receiving a request, from one of said more than one multiple server computers from which said duplicate file was removed, to backup said removed duplicate file, allowing only said stub of said removed duplicate file on said requesting server computer to be backed up.

9. The method of claim 1, wherein storing information about said removed duplicate file includes storing an inventory including at least one identifying attribute of all duplicate files removed from one of said multiple server computers, said inventory stored at said one of said multiple server computers.

10. The method of claim 1, wherein storing information about said removed duplicate file includes storing an inventory including at least one identifying attribute of all duplicate files removed from each of said multiple server computers, said inventory stored at said common storage area.

11. The method of claim 1, wherein storing information about said removed duplicate file includes storing an inventory including at least one identifying attribute of duplicate files removed, said inventory stored on some specified multiple server computers and at said common storage area for other of said multiple server computers.

12. The method of claim 1, further comprising, in response to receiving a request to replace said removed duplicate file, replacing said removed duplicate file back onto said more than one of said multiple server computers from which said duplicate file was removed.

13. The method of claim 1, further comprising, in response to receiving a request from one of said more than one multiple server computers to update said removed duplicate file, replacing said removed duplicate file back onto said more than one of multiple server computers and performing said update on said requesting server computer's replaced file.

14. The method of claim 1, further comprising upon receiving a request to read said removed duplicate file, redirecting said read request to said common storage area where said copy of said duplicate file is stored.

15. The method of claim 1, further comprising, in response to receiving a request from one of said more than one multiple server computers to backup said removed duplicate file, sending entire contents of said removed duplicate file to requesting server computer's backup routine.

16. The method of claim 1, further comprising, in response to receiving a request from one of said more than one of said multiple server computers to update said removed duplicate file, and upon determining that there is no copy of said removed duplicate file with said requested update already applied is on said common storage area, creating said requested updated copy of said removed duplicate file on said common storage area.

17. The method of claim 16, wherein said update request is to change blocks of said removed duplicate file, and determining that there is no copy of said removed duplicate file with said requested update, includes determining that there is no copy of said requested changed blocks of said removed duplicate file on said common storage area, and creating said requested update of said removed duplicate file on said common storage area includes creating said changed blocks of said removed duplicate file on said common storage area.

18. The method of claim 17, further comprising:
providing a version history common storage area accessible to all of said multiple server computers;
storing copies of said changed blocks of said updated copy of said removed duplicate files on said version history common storage area; and
storing copies of unchanged blocks of said updated copy of said removed duplicate files on said common storage area.

19. The method of claim 18, further comprising replacing entire contents of said updated copy of said removed duplicate file back onto said more than one of said multiple server computers, when a user specified limit on the number of said changes to blocks of said updated copy of said removed duplicate file stored on said version history common storage area has been reached.

20. The method of claim 19, further comprising adding said replaced updated duplicate file to the a black list of files that should not be de-duplicated.

21. The method of claim 16, further comprising, prior to creating said requested updated copy of said removed duplicate file on said common storage area, storing said update on said requesting server computer, and at a later time, creating said requested updated copy of said removed duplicate file on said common storage area and removing said update from said requesting server computer.

22. The method of claim 21, wherein said update is stored on said requesting server in a stub at the place where said duplicate file to be updated was removed from said requesting server computer.

23. The method of claim 1, further comprising adding at least one additional common storage area and communicating the existence of said at least one additional common storage area to existing common storage area and multiple server computers.

24. The method of claim 23, further comprising storing said communications about said at least one additional common storage area.

25. The method of claim 24, further comprising:
determining that at least one of said multiple servers was offline when said additional common storage area was added; and
upon said at least one offline server computer coming back online, communicating the existence of said at least one additional common storage area to said at least one server computer offline when said at least one additional common storage area was added.

26. The method of claim 23, further comprising storing on all of said common storage areas a complete list of all duplicate files removed from said multiple server computers.

27. The method of claim 23, further comprising removing a redundant common storage area and communicating said removal of said redundant common storage area to all remaining common storage areas and multiple server computers.

28. The method of claim 27, further comprising storing said communications about said removed common storage area.

29. The method of claim 28, further comprising:
determining that at least one of said multiple server computers was offline when said redundant common storage area was removed; and
upon said at least one offline server computer coming back online, communicating said removed common storage area to said at least one server computer determined to be offline when said redundant common storage area was removed.

30. The method of claim 1, further comprising moving the location of said common storage area and communicating said moved common storage area location to all remaining common storage areas and multiple server computers.

31. The method of claim 30, further comprising storing said communications about said moved common storage area location.

32. The method of claim 31, further comprising:
determining that at least one of said multiple servers was offline when said common storage area location was moved; and
upon said at least one offline server computer coming online, communicating said moved common storage area location to said at least one server computer determined to be offline when said common storage area location was moved.

33. The method of claim 1, further comprising storing a copy of said duplicate file on more than one common storage area accessible to said multiple server computers.

34. The method of claim 33, upon determining that one of said more than one common storage areas is unavailable, accessing said duplicate file on a different one of said more than one common storage areas.

35. The method of claim 33, upon determining that one of said more than one common storage areas is very slow, accessing said duplicate file on a different one of said more than one common storage areas.

36. The method of claim 33, further comprising accessing said duplicate file on said more than one common storage areas based on a user specified order.

37. The method of claim 36, wherein the user specified access order is any one of the following:
(a) round robin;
(b) fixed order list;
(c) random order; and
(d) demonstrated common storage area performance order.

38. The method of claim 1, further comprising providing user settable options for any combination of one or more of the following:
(a) white list;
(b) black list;
(c) length of time for monitoring access to files to determine read only access;
(d) specifying stub method for tracking removed duplicate files;
(e) specifying inventory method for tracking removed duplicate files;
(f) specifying location where inventory of removed duplicate files is to be stored;
(g) specifying type of information about removed duplicate files to be stored;
(h) requesting and specifying previously removed duplicate files to be replaced back onto said multiple server computers;
(i) specifying rehydrate update option for said removed duplicate file;
(j) specifying asynchronous updates for said removed duplicate file;
(k) specifying backups of entire contents of said removed duplicate file;
(l) specifying allowing backups of stub only of said removed duplicate file; and
(m) specifying limit of number of changes to track for version history.

39. A multiple server computer system for performing file de-duplication, wherein said multiple server computers are connected to each other and to a common storage area, wherein each server computer includes an operating system and an operating system level file driver, and wherein each server computer is operable to perform the method recited in claim 1.

40. A server computer system having a processor, a memory, an operating system, and an operating system level file driver, for performing file de-duplication, comprising:
a connection to multiple server computers;
a connection to a common storage area;
wherein said operating system is operable to perform the method recited in claim 1.

41. The server computer system of claim 40, wherein said operating system level file driver is operable to intercept a read to a specified duplicate file and redirect said read to read from said common storage system at a different location than where said operating system believes the specified file to be located.

42. The server computer system of claim 40, wherein said operating system level file driver is operable to intercept a write to a specified removed duplicate file, replace said removed duplicate file back onto said server computer and perform said write on said server computer's replaced file.

43. The server computer system of claim 40, wherein said operating system level file driver is operable to intercept an update to a specified removed duplicate file, and upon determining that there is no copy of said removed duplicate file with said requested update already applied is on said common storage area, creating said requested updated copy of said removed duplicate file on said common storage area.

44. A computer readable medium containing computer-readable instructions, which when executed by a computer perform the method recited in claim 1.

45. A computer readable medium containing computer-readable instructions, which when executed by a computer perform the method recited in claim 13.

46. A computer readable medium containing computer-readable instructions, which when executed by a computer perform the method recited in claim 14.

47. A computer readable medium containing computer-readable instructions, which when executed by a computer perform the method recited in claim 16.
